(19) United States
(12) Patent Application Publication
(10) Pub. No.: US 2023/0100935 A1
(43) Pub. Date: Mar. 30, 2023

(54) MICROSERVICE DEPLOYMENTS USING ACCELERATORS

(71) Applicant: Intel Corporation, Santa Clara, CA (US)

(72) Inventors: Kelley MULLICK, Hillsboro, OR (US); Mrittika GANGULI, Chandler, AZ (US); Brian P. JOHNSON, Forest Grove, OR (US); Matthew J. ADILETTA, Bolton, MA (US)

(21) Appl. No.: 18/075,262

(22) Filed: Dec. 5, 2022

Related U.S. Application Data
(60) Provisional application No. 63/416,821, filed on Oct. 17, 2022.

(51) Int. Cl. G06F 9/50; G06F 9/54

(52) U.S. Cl. CPC G06F 9/5083; G06F 9/505; G06F 9/547; G06F 9/546

(57) ABSTRACT

Examples described herein relate to circuitry to perform load balancing; at least one memory; and at least one processor. In some examples, at least one processor is to execute instructions stored in the at least one memory that cause the at least one processor to: execute a communication proxy that is to allocate packet data to the circuitry to perform load balancing to allocate workloads among cores and allocate received and transmitted remote procedure calls to at least one queue in circuitry to queue one or more packets.

### RELATED APPLICATION

This application claims priority to U.S. Provisional Application 63/416,821, filed Oct. 17, 2022. The entire contents of that application are incorporated by reference in its entirety.

### BACKGROUND

Data centers are shifting from deploying monolithic applications to applications composed of communicatively coupled microservices. Applications can be composed of microservices that are independent, composable services that communicate through application program interfaces (APIs) in a single server or distributed servers. However, central processing unit (CPU) utilization for communications among of microservices can introduce latency into communications and present an inefficient use of CPU resources as CPU resources can be utilized for other billable purposes. In addition, workload performance, memory, and storage utilization impact latency of communications between microservices as well as speed of execution of microservices.

### BRIEF DESCRIPTION OF THE DRAWINGS

FIG. 1 depicts an example system.

FIG. 2 depicts an example implementation.

FIG. 3 is an illustration of a processing system.

FIG. 4 depicts an example of CPU utilization and latency from use of a load balancer to manage traffic received by a proxy.

FIG. 5 depicts an example queue system.

FIG. 6 depicts an example system.

FIG. 7 depicts an example of latency savings and CPU cycles savings from use of queue system.

FIG. 8 depicts an example system.

FIG. 9 depicts an example system.

### DETAILED DESCRIPTION

In an environment that executes microservices or other virtual execution environments, at least to attempt to reduce latency of communications and to attempt to reduce utilization of processors, in some examples, a proxy can utilize a load balancer accelerator to allocate packet data for processing by processor cores and remote procedure calls can utilize a queue system for transmitted and received communications. Certain communications (e.g., remote procedure calls (RPC) or Memcached requests) can be allocated one or more queues exclusively to provide a quality of service of transmission of the communications and/or processing of the communications. Use of a load balancer to balance traffic among cores or processors and a queue system for certain traffic can reduce tail latency of communications between microservices. Tail latency can refer to low probability worst-case communication latencies.

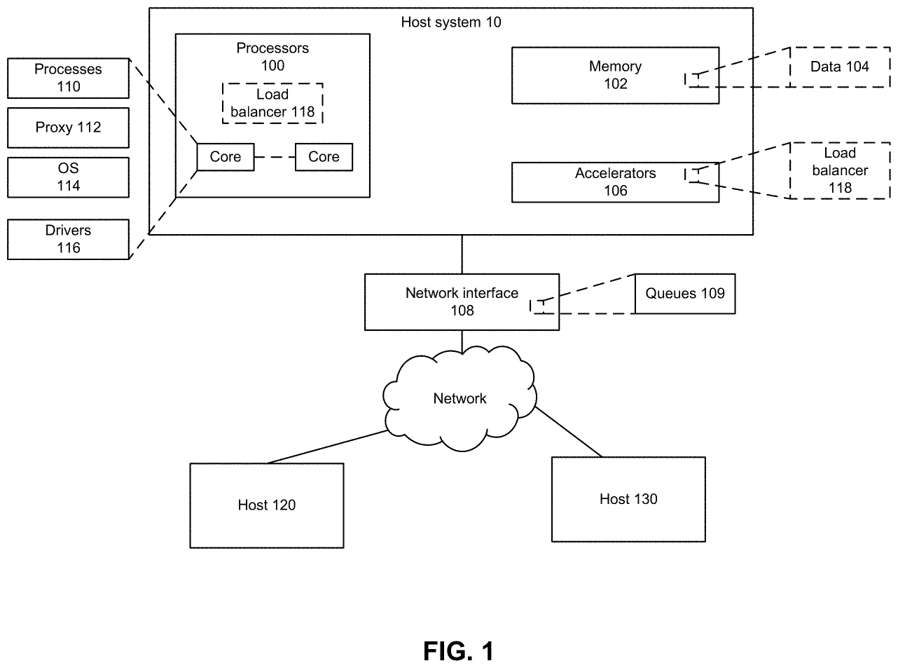

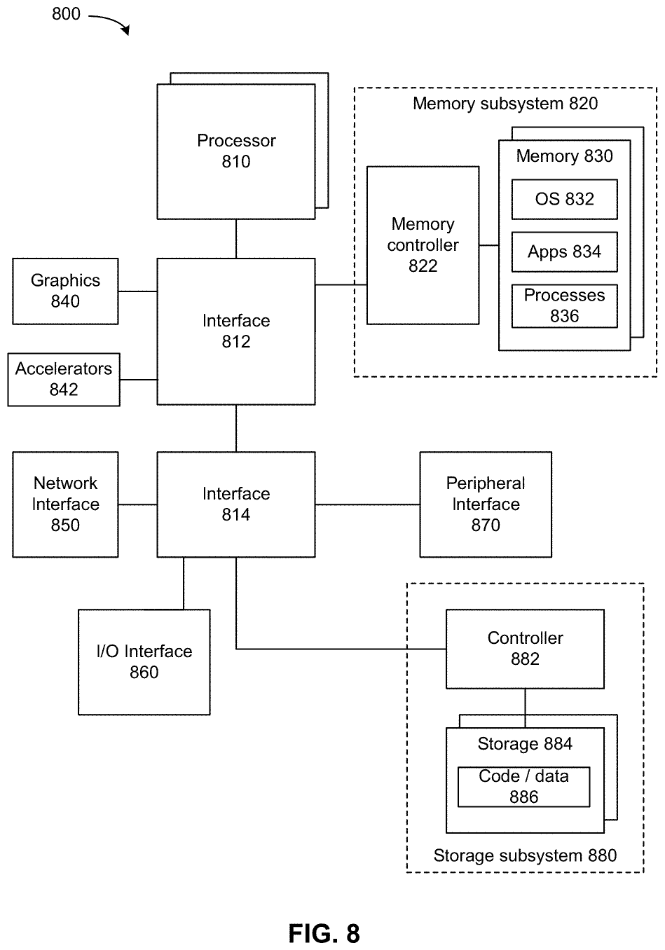

FIG. 1 depicts an example system. Various examples of hardware and software utilized by host system 10, 120, and/or 130 are described at least with respect to FIGS. 8 and/or 9. Host system 10 can include processors 100 that execute one or more of: processes 110, operating system (OS) 114, and device driver 116. For example, processors 100 can include a central processing unit (CPU), graphics processing unit (GPU), accelerator, or other processors described herein. Processes 110 can include one or more of: application, process, thread, a virtual machine (VM), microVM, container, microservice, or other virtualized execution environment. Note that application, process, thread, VM, microVM, container, microservice, or other virtualized execution environment can be used interchangeably.

A microservice can communicate with other microservices using protocols (e.g., application program interface (API), a Hypertext Transfer Protocol (HTTP) resource API, message service, remote procedure calls (RPC), Google RPC (gRPC), Apache Thrift, or others). Microservices can communicate with one another using an interface to a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery

A service mesh can include an infrastructure layer for facilitating service-to-service communications between microservices using application programming interfaces (APIs). A service mesh interface can be implemented using a proxy instance (e.g., sidecar) to manage service-to-service communications. Some network protocols used by microservice communications include Layer 7 protocols, such as Hypertext Transfer Protocol (HTTP), HTTP/2, remote procedure call (RPC), gRPC, Kafka, MongoDB wire protocol, and so forth. Envoy Proxy is a well-known data plane for a service mesh. Istio, AppMesh, Nginx, and Open Service Mesh (OSM) are examples of control planes for a service mesh data plane.

A sidecar can execute in a container. A sidecar can perform offloaded operations from containers or microservices that communicate with a service mesh, such as SSL/mTLS, traffic routing, high availability, and so forth. An example sidecar includes Nginx. In some examples, performance of operations of a sidecar can be offloaded to a load balancer and accelerated using the load balancer. In some examples, synchronization between the sidecar and processor can be performed using the load balancer.

Microservices can utilize web proxies to intercept HTTP2 traffic. Hypertext Transfer Protocol (HTTP) is a generic, stateless, object-oriented application-level protocol that can be used for many tasks, such as name servers and distributed object management systems, through extension of its request methods (i.e., commands). A feature of HTTP is use of type representations (e.g., object types, data object types, etc.) that allow systems to be built independently of the data being transferred. Some webservers use HTTP to execute webserver requests from client devices (e.g., Internet-enabled smartphones, tablets, laptop computers, desktop computers, Internet of Things (IoT) devices, edge devices, etc.). Some such webserver requests are for media, such as audio, video, and/or text-based media. Hypertext Transfer Protocol Secure (HTTPS) is the secure version of the HTTP protocol that uses the Secure Sockets Layer (SSL)/Transport Layer Security (TLS) protocol for encryption and authentication.

Some webservers process webserver requests using HTTP1 (also referred to as HTTP/1.0) or HTTP1.1 (also referred to as HTTP/1.1) whereas some commercial webservers are transitioning from HTTP1 to newer versions of HTTP such as HTTP2 (also referred to as HTTP/2), HTTP3 (also referred to as HTTP/3), HTTP Secure (HTTPS) Attestation (also referred to as HTTPA), etc. Unlike HTTP1, newer versions of HTTP can be binary protocols. For example, HTTP2, HTTP3, etc., can handle messages that include binary commands in the form of 0s and 1s to be transmitted over a communication channel or medium. The binary framing layer can divide the messages into frames, which are partitioned based on their type, such as header frames or data frames. In HTTP2, HTTP3, etc., the data frames may include different types of data such as audio data, video data, text data, etc. For example, HTTP2, HTTP3, etc., supports multiple data types (e.g., audio, video, text, etc.) in a single request. In some examples, a client device (e.g., a device operating as a client in client-server communication) may transmit a request for multiple individual objects such as audio, video, text, etc.

HTTP2/3 introduced multiple objects in the same connections. In some HTTP2/HTTP3 commercial webservers, multi-object requests can create uneven core utilization (e.g., processor core utilization) at a server (e.g., host system). For example, a first worker core (e.g., a first worker core of multi-core processor circuitry of a server) may be overutilized when serving a multi-object request while other worker cores (e.g., second worker cores of multi-core processor circuitry of a server) are underutilized. In some examples, the uneven core utilization may lead to a performance degradation of the server. Some HTTP2/HTTP3 commercial webservers use software load balancers to address the uneven core utilization. However, software load balancers can be inefficient when processing HTTP2/HTTP3 requests that include multiple, different object types. For example, different object types need different amounts of hardware resources (e.g., different numbers of cores of processor circuitry, memory, mass storage, etc.) to be processed. For example, a microservice can receive and respond to traffic as a multi-threaded model webserver. For example, YouTube video can include mixed traffic, e.g., 1 MB (Video), 100 KB (text), 10 KB (Transactional). HTTP2 allows prioritizing such traffic with a Priority Order of 1 MB—P0, 100 KB—P1, 10 KB—P2. Distribution across cores in not even, some cores are more occupied than the others.

Host 120 and/or host 130 can execute one or more processes (e.g., application, process, thread, VM, microVM, container, microservice, or other virtualized execution environment) that communicate with one or more of processes 110. As described herein, processes 110 can communicate with one or more processes executed on host 120 and/or 130 using a proxy 112 (e.g., sidecar) executed on processors 100, accelerators 106, and/or network interface 108. Proxy 112 can utilize load balancer 118 to load balance work performed by accelerators 106 for inbound and outbound communications. Communications (e.g., remote procedure calls (RPC) or Memcached requests) transmitted to one or more processes executed on host 120 and/or 130 and/or received from one or more processes executed on host 120 and/or 130 can be allocated to queues 109 in or available to network interface device 108. In some examples, network interface device 108 can be implemented as one or more of: a network interface controller (NIC), a remote direct memory access (RDMA)-enabled NIC, SmartNIC, router, switch, forwarding element, infrastructure processing unit (IPU), or data processing unit (DPU).

In some examples, load balancer 118 can include Intel® Dynamic Load Balancer (Intel® DLB) or a hardware managed system of queues and arbiters connecting producers of data and consumers of data. Load balancer 118 can be accessed as a PCI device or in a CPU uncore or system agent and can interact with software running on cores, and potentially with other devices. An uncore or system agent can include or more of a memory controller, a shared cache (e.g., last level cache (LLC)), a cache coherency manager, arithmetic logic units, floating point units, core or processor interconnects, Caching/Home Agent (CHA), or bus or link controllers. System agent can provide one or more of: direct memory access (DMA) engine connection, non-cached coherent master connection, data cache coherency between cores and arbitrates cache requests, or Advanced Microcontroller Bus Architecture (AMBA) capabilities.

Queues 109 can include Intel® Application Device Queue (ADQ) or circuitry that can accelerate processing of packets received through multiple connections by a central processing unit (CPU) core by grouping connections together under the same identifier (e.g., NAPI_ID) and avoiding locking or stalling from contention for queue accesses (e.g., reads or writes). Queues 109 can reduce network traffic arising from different applications or processes attempting to access the same queue and cause locking or contention, which can increase latency of packet availability and make packet availability unpredictable. Moreover, queues 109 can provide quality of service (QoS) control for dedicated application traffic queues for received packets or packets to be transmitted. Queues 109 can use busy polling to reduce packet processing latency and jitter. Busy polling can be a static configuration whereby with some busy polling configurations, a one-to-one mapping between queues and threads is made, so that for x queues and y threads, z cores are fully consumed, independent of the load. In other words, regardless of packet processing throughput in terms of transactions/second, z cores are utilized even if fewer cores can be used such as for P50, P90, or P99 service level agreement (SLA) latency parameters.

Device driver 116 can include a device driver at least for load balancer 118 and/or queues 109. Libdlb can use driver for load balancer 118 and an application can use a modified libdlb. In some examples, use of load balancer 118 can save more than 40% CPU resources for a 10 core allocation to ingress proxy and use of queues 109 for remote procedure call (RPC) communications between microservices can save >60% usage on 16 cores.

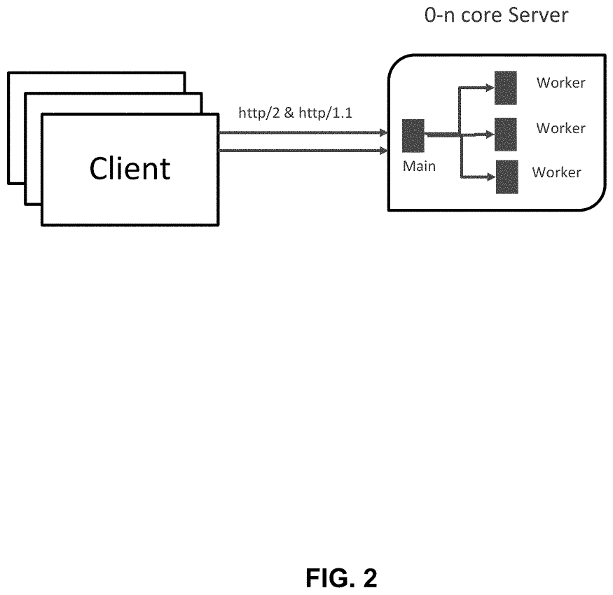

FIG. 2 depicts an example implementation. Clients can include different devices (e.g., laptops, tablets, phones, servers, and so forth) issues request to microservices. Distribution of work across cores can be uneven, as some cores are more loaded than other cores. In some examples, as described herein, a web proxy can offload to load balancer (e.g., DLB or other circuitry) to load balance work among CPU cores that execute worker threads. A main thread (e.g., proxy) (shown as “Main”) can execute on a CPU core and monitor or intercept traffic from a client and route traffic to load balancer queue. Cores can be mapped to load balancer queues so that one or more cores processes packet traffic allocated to one or more load balancer queues.

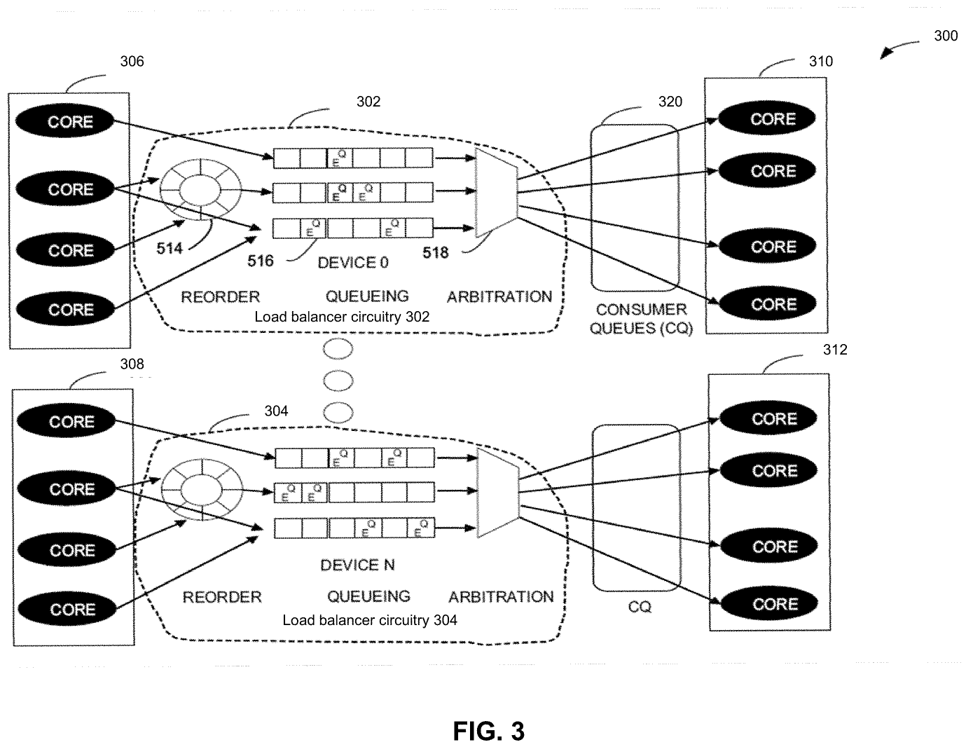

FIG. 3 is an illustration of a processing system 300 including load balancer circuitry. In some examples, load balancer circuitry include one or more of DLB circuitry 302 and DLB circuitry 304, although other circuitries can be used. In some examples, the first DLB circuitry 302 and/or the second DLB circuitry 304 can be implemented by a Dynamic Load Balancer provided by Intel® Corporation of Santa Clara, Calif. Processing system 300 of the illustrated example includes producer cores 306 (e.g., that execute at least one instance of a proxy) and producer cores 308 (e.g., that execute at least one instance of a proxy). In some examples, producer cores 306 and producer cores 308 are in communication with a respective one of DLB circuitry 302, 304. In some examples, consumer cores 310 and consumer cores 312 are in communication with a respective one of DLB circuitry 302, 304. In some examples, fewer or more than instances of DLB circuitry 302, 304 and/or fewer or more than producer cores 306, 308 and/or consumer cores 310, 312 depicted in the illustrated example may be used. In some examples, there is no cross-device arbitration (e.g., DEVICE 0 does not arbitrate for DEVICE N), however, in other examples, there may be cross-device arbitration.

In some examples, DLB circuitry 302, 304 correspond to a hardware-managed system of queues and arbiters that link the producer cores 306, 308 and consumer cores 310, 312. In some examples, one or both of DLB circuitry 302, 304 can be accessible as a PCI or PCI-E device. In some examples, one or both of DLB circuitry 302, 304 can be an accelerator (e.g., a hardware accelerator) included either in processor circuitry or in communication with the processor circuitry.

In some examples, DLB circuitry 302, 304 can include example reorder circuitry 314, queueing circuitry 316, and arbitration circuitry 318. In some examples, reorder circuitry 314, queueing circuitry 316, and/or arbitration circuitry 318 can be implemented with hardware alone. In some examples, reorder circuitry 314, queueing circuitry 316, and/or arbitration circuitry 318 can be implemented by hardware, software, firmware and/or any combination of hardware, software and/or firmware.

In some examples, reorder circuitry 314 can obtain data from one or more of the producer cores 306, 308 and facilitate reordering operations based on the data. For example, reorder circuitry 314 can inspect a data pointer from one of the producer cores 306, 308. In some examples, the data pointer can be associated with an object type of an HTTP request (or an HTTPS request, an HTTPA request, etc.). In some examples, reorder circuitry 314 can determine that the data pointer is associated with a known data sequence. In some examples, producer cores 306, 308 can enqueue the data pointer with the queueing circuitry 316 because the data pointer is not associated with a known data flow and may not be needed to be reordered and/or otherwise processed by reorder circuitry 314.

In some examples, reorder circuitry 314 can store the data pointer and other data pointers associated with data packets in the known data flow in a buffer (e.g., a ring buffer, a first-in first-out (FIFO) buffer, etc.) until a portion of or an entirety of the data pointers in connection with the known data flow are obtained and/or otherwise identified. In some examples, reorder circuitry 314 can transmit the data pointers to one or more of the queues controlled by the queueing circuitry 316 to maintain an order of the known data sequence. For example, the queues can store the data pointers as queue elements (QEs).

Queueing circuitry 316 can include a plurality of queues or buffers to store data pointers or other information. In some examples, queueing circuitry 316 can transmit data pointers in response to filling an entirety of the queue(s). In some examples, queueing circuitry 316 transmits data pointers from one or more of the queues to arbitration circuitry 318 on an asynchronous or synchronous basis.

In some examples, arbitration circuitry 318 can be configured and/or instantiated to perform an arbitration by selecting a given one of consumer cores 310, 312. For example, arbitration circuitry 318 can include and/or implement one or more arbiters, sets of arbitration circuitry (e.g., first arbitration circuitry, second arbitration circuitry, etc.), etc. In some examples, respective ones of the one or more arbiters, the sets of arbitration circuitry, etc., can correspond to a respective one of consumer cores 310, 312. In some examples, arbitration circuitry 318 is based on consumer readiness (e.g., a consumer core having space available for an execution or completion of a task), task availability, etc. In example operation, arbitration circuitry 318 can execute and/or carry out a passage of data pointers from the queueing circuitry 316 to example consumer queues 320. In some examples, consumer queues 320 can be implemented by and/or correspond to consumer queues.

In some examples, consumer cores 310, 312 are in communication with consumer queues 320 to obtain data pointers for subsequent processing. In some examples, a length (e.g., a data length) of one or more of consumer queues 320 are programmable and/or otherwise configurable. In some examples, DLB circuitry 302, 304 can generate an interrupt (e.g., a hardware interrupt) to one(s) of consumer cores 310, 312 in response to a status, a change in status, etc., of consumer queues 320. Responsive to the interrupt, the one(s) of consumer cores 310, 312 can retrieve the data pointer(s) from consumer queues 320.

In some examples, DLB circuitry 302, 304 can check a status (e.g., a status of being full, not full, not empty, partially full, partially empty, etc.) of consumer queues 320. In some examples, DLB circuitry 302, 304 can track fullness of consumer queues 320 by observing enqueues on an associated producer port (e.g., a hardware port) of DLB circuitry 302, 304. For example, in response to an enqueueing, DLB circuitry 302, 304 can determine that a corresponding one of consumer cores 310, 312 has completed work on and/or associated with a QE and, thus, a location of the QE is now available in the queues controlled by the queueing circuitry 316. For example, a format of the QE can include a bit that is indicative whether a consumer queue token (or other indicia or datum), which can represent a location of the QE in consumer queues 320, is being returned. In some examples, new enqueues that are not completions of prior dequeues do not return consumer queue tokens because there is no associated entry in consumer queues 320.

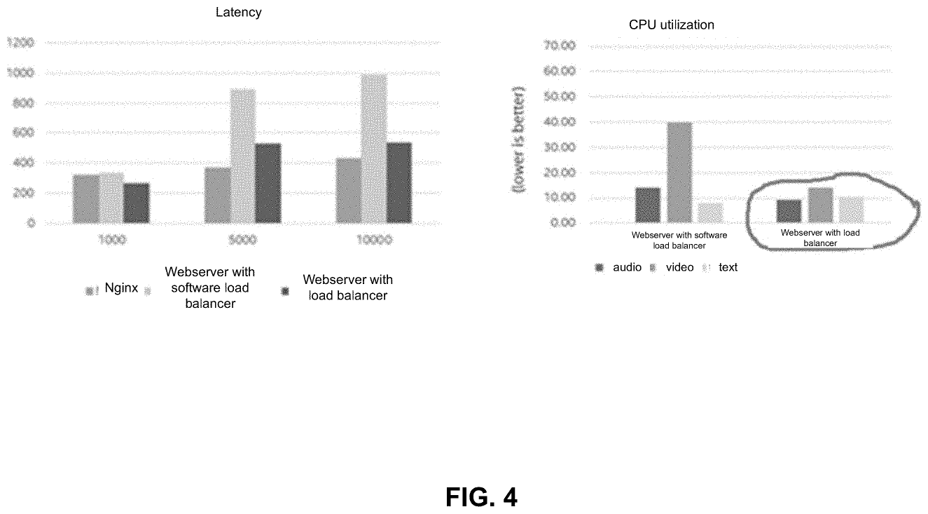

FIG. 4 depicts an example of CPU utilization and latency from use of a load balancer circuitry to manage traffic received by a proxy. A set of cores can be allocated for ingress traffic for a webservice (e.g., proxy or memcached). Offload of allocation of traffic to cores by a load balancer circuitry can save CPU cycles worth 3-4 cores, in some examples.

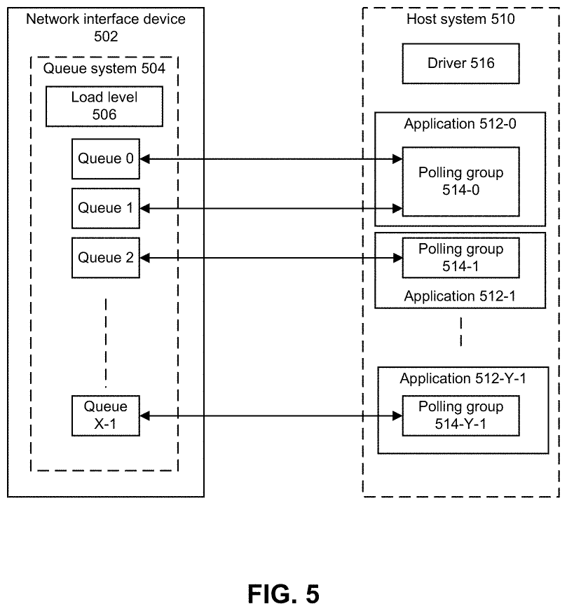

FIG. 5 depicts an example queue system. Network interface device 502 can utilize queue system 504 with queues 0 to X-1 available for access by threads executing applications 512-0 to 512-Y-1, where X and Y are integers. In some examples, network interface device 502 can allocate content to storage in one or more of queues 0 to X-1 in memory on network interface device 502 and/or on host system 510. For example, X queues can be assigned a unique NAPI_ID or identifier value. A thread running a polling group can be allocated a subset of N different NAPI_IDs, so that a polling group exclusively accesses a queue or queues associated with the allocated one or more NAPI_IDs and no other polling group accesses the queue or queues. Network interface device 502 can be a device that includes a hardware queue manager, host interface, fabric interface, and so forth.

In this example, applications 512-0 to 512-Y-1 can utilize polling groups 504-0 to 504-Y-1 to poll for new work or received packets to process contents of queues 0 to X-1. For example, polling group 504-0 can poll for work in queues 0 and 1, whereas polling group 504-1 can poll for work in queue 2, and so forth. In other words, a polling group can poll for work in one or multiple queues. Queues can be allocated to an application thread, and these queues can be exclusively accessed by thread(s) that execute associated applications. Polling groups 504-0 to 504-Y-1 can perform busy polling of queues directly to detect for whether packets are received and available for processing.

Applications 512-0 to 512-Y-1 can be implemented as a service, microservice, cloud native microservice, workload, or software. Applications 512-0 to 512-Y-1 can represent multiple threads executing of a same application. Applications 512-0 to 512-Y-1 can represent multiple threads executing of different applications. Applications 512-0 to 512-Y-1 can represent one or more devices, such as a field programmable gate array (FPGA), an accelerator, or processor. Any application or device can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in VEEs. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files).

Although examples are provided with respect to a network interface device, other devices can be used instead or in addition, such as a storage controller, memory controller, fabric interface, processor, and/or accelerator device.

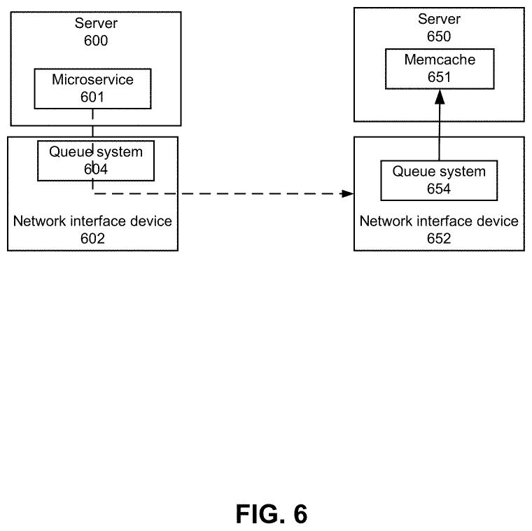

FIG. 6 depicts an example system. An application or driver executing on server 600 can configure a filter or circuitry in network interface device 602 to send traffic for memcached 651 to queue system resources 604 to network interface device 652 to provide to memcached 651. Memcached traffic can be routed into queues of queue system 604 in sender network interface device 602 to isolate memcached traffic. Queue system 604 can provide quality of service (QoS) for memcached traffic to be transmitted to server 650. Use of queue system 604 can allow for lower P states of processors in server 600 and lower frequency of operation. Queue system 604 can save processor cycles because of context sharing for microservices involved in transmit and receive operations and less memory movement. In some examples, an application (e.g., microservice client 601) executing on server 600 can transmit packets to memcached 651 in a busy poll fashion.

For example, microservice client 601 executing on server 600 can issue key requests to be transmitted using network interface device 602 to memcached server 650. At receiver server 650, memcached traffic arrives at network interface device 652, which can filter the traffic to provide memcached traffic to queue system 654 to isolate memcached traffic to particular queues and associated CPU cores. A CPU core on server 650 can busy poll queues of queue system 654 allocated to memcached to identify incoming traffic for memcached 651. Memcached 651 can respond with a key that identifies an entry to be retrieved. Memcached 651 can include and/or access an in-memory key-value store for chunks of data (e.g., strings, objects) from results of database calls, application program interface (API) calls, or page rendering. An example of memcached 651 can include Twemcache.

Although examples are described with respect to memcached, techniques can apply to microservices requests sent using such as remote procedure calls (RPC) including gRPC.

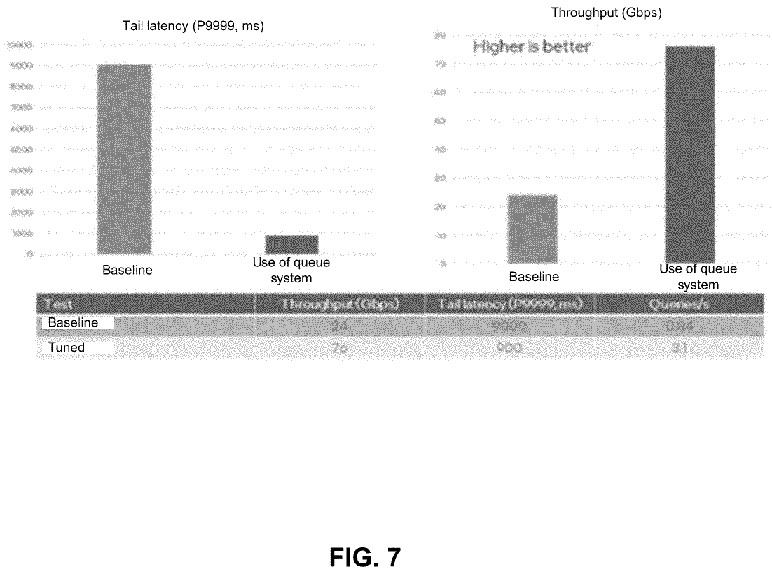

FIG. 7 depicts an example of latency savings and CPU cycles savings from use of queue system. For example, 9-13 cores can be saved from use of queue system for memcached requests and RPCs.

FIG. 8 depicts a system. In some examples, operation of processors 810 and/or network interface 850 can configured to utilize a load balancer and a queue system for load balancing traffic and/or processing memcached requests or remote procedure calls, as described herein. Processor 810 can include any type of microprocessor, central processing unit (CPU), graphics processing unit (GPU), XPU, processing core, or other processing hardware to provide processing for system 800, or a combination of processors. An XPU can include one or more of: a CPU, a graphics processing unit (GPU), general purpose GPU (GPGPU), and/or other processing units (e.g., accelerators or programmable or fixed function FPGAs). Processor 810 controls the overall operation of system 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 800 includes interface 812 coupled to processor 810, which can represent a higher speed interface or a high throughput interface for system components that needs higher bandwidth connections, such as memory subsystem 820 or graphics interface components 840, or accelerators 842. Interface 812 represents an interface circuit, which can be a standalone component or integrated onto a processor die. Where present, graphics interface 840 interfaces to graphics components for providing a visual display to a user of system 800. In one example, graphics interface 840 can drive a display that provides an output to a user. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a programmable or fixed function offload engine that can be accessed or used by a processor 810. For example, an accelerator among accelerators 842 can provide data compression (DC) capability, cryptography services such as public key encryption (PKE), cipher, hash/authentication capabilities, decryption, or other capabilities or services. In some embodiments, in addition or alternatively, an accelerator among accelerators 842 provides field select controller capabilities as described herein. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 842 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 820 represents the main memory of system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

Applications 834 and/or processes 836 can refer instead or additionally to a virtual machine (VM), container, microservice, processor, or other software. Various examples described herein can perform an application composed of microservices.

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host. In some examples, an operating system can issue a configuration to a data plane of network interface 850.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

In some examples, OS 832 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others. In some examples, OS 832 or driver can configure a load balancer and a queue system for load balancing traffic and/or processing memcached requests or remote procedure calls, as described herein.

While not specifically illustrated, it will be understood that system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides system 800 the ability to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. In some examples, network interface 850 or network interface device 850 can refer to one or more of: a network interface controller (NIC), a remote direct memory access (RDMA)-enabled NIC, SmartNIC, router, switch (e.g., top of rack (ToR) or end of row (EoR)), forwarding element, infrastructure processing unit (IPU), or data processing unit (DPU). An example IPU or DPU is described at least with respect to FIG. 12.

In one example, system 800 includes one or more input/output (I/O) interface(s) 860. Peripheral interface 870 can include any hardware interface not specifically mentioned above. Peripherals refer generally to devices that connect dependently to system 800. A dependent connection is one where system 800 provides the software platform or hardware platform or both on which operation executes, and with which a user interacts.

In one example, system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (e.g., the value is retained despite interruption of power to system 800). Storage 884 can be generically considered to be a “memory,” although memory 830 is typically the executing or operating memory to provide instructions to processor 810. Whereas storage 884 is nonvolatile, memory 830 can include volatile memory (e.g., the value or state of the data is indeterminate if power is interrupted to system 800). In one example, storage subsystem 880 includes controller 882 to interface with storage 884. In one example controller 882 is a physical part of interface 814 or processor 810 or can include circuits or logic in both processor 810 and interface 814. A volatile memory is memory whose state (and therefore the data stored in it) is indeterminate if power is interrupted to the device. A non-volatile memory (NVM) device is a memory whose state is determinate even if power is interrupted to the device.

In an example, system 800 can be implemented using interconnected compute nodes of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; chiplet-to-chiplet communications; circuit board-to-circuit board communications; and/or package-to-package communications. A die-to-die communications can utilize Embedded Multi-Die Interconnect Bridge (EMIB) or an interposer.

In an example, system 800 can be implemented using interconnected compute sleds of processors, memories, storages, network interfaces, and other components. High speed interconnects can be used such as PCIe, Ethernet, or optical interconnects (or a combination thereof).

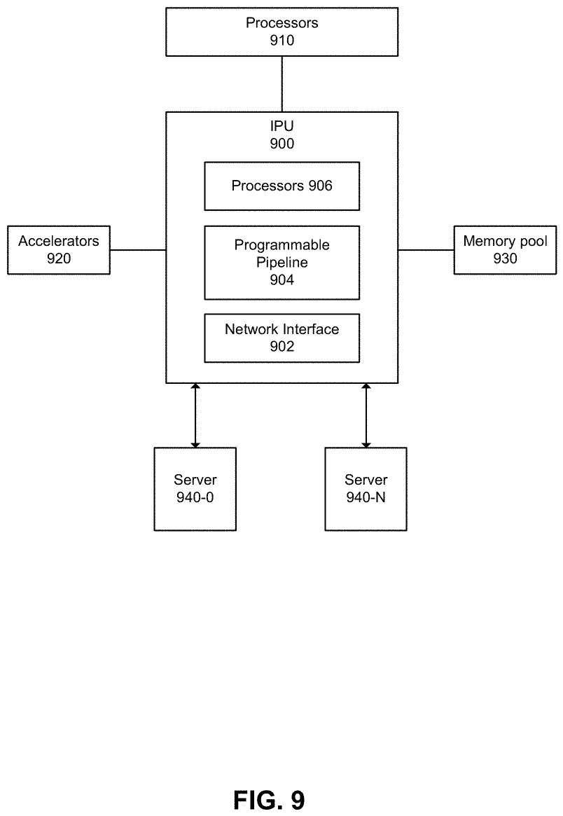

FIG. 9 depicts an example system. Devices and software of system 900 can utilize a load balancer and a queue system for load balancing packet traffic and/or processing memcached requests or remote procedure calls, as described herein. In this system, IPU 900 manages performance of one or more processes using one or more of processors 906, processors 910, accelerators 920, memory pool 930, or servers 940-0 to 940-N, where N is an integer of 1 or more. In some examples, processors 906 of IPU 900 can execute one or more processes, applications, VMs, containers, microservices, and so forth that request performance of workloads by one or more of: processors 910, accelerators 920, memory pool 930, and/or servers 940-0 to 940-N. IPU 900 can utilize network interface 902 or one or more device interfaces to communicate with processors 910, accelerators 920, memory pool 930, and/or servers 940-0 to 940-N. IPU 900 can utilize programmable pipeline 904 to process packets that are to be transmitted from network interface 902 or packets received from network interface 902.

In some examples, devices and software of IPU 900 can perform capabilities of a router, load balancer, firewall, TCP/reliable transport, service mesh interface, data-transformation, authentication, security infrastructure services, telemetry measurement, event logging, initiating and managing data flows, data placement, or job scheduling of resources on an XPU, storage, memory, or central processing unit (CPU).

In some examples, devices and software of IPU 900 can perform operations that include data parallelization tasks, platform and device management, distributed inter-node and intra-node telemetry, tracing, logging and monitoring, quality of service (QoS) enforcement, service mesh interface, data processing including serialization and deserialization, transformation including size and format conversion, range validation, access policy enforcement, or distributed inter-node and intra-node security.

Programmable pipeline 904 can include one or more packet processing pipeline that can be configured to perform match-action on received packets to identify packet processing rules and next hops using information stored in a ternary content-addressable memory (TCAM) tables or exact match tables in some embodiments. Programmable pipeline 904 can include one or more circuitries that perform match-action operations in a pipelined or serial manner that are configured based on a programmable pipeline language instruction set. Processors, FPGAs, other specialized processors, controllers, devices, and/or circuits can be used utilized for packet processing or packet modification. For example, match-action tables or circuitry can be used whereby a hash of a portion of a packet is used as an index to find an entry. Programmable pipeline 904 can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of programmable pipeline 904, including its data plane, can be programmed based on one or more of: one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries, or others.

Programmable pipeline 904 and/or processors 906 can utilize a load balancer and a queue system for load balancing packet traffic and/or processing memcached requests or remote procedure calls, as described herein.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

What is claimed is:

1. An apparatus comprising:
circuitry to perform load balancing;
at least one memory; and
at least one processor, wherein the at least one processor is to execute instructions stored in the at least one memory that cause the at least one processor to:
execute a communication proxy that is to allocate packet data to the circuitry to perform load balancing to allocate workloads among cores and
allocate received and transmitted remote procedure calls to at least one queue in circuitry to queue one or more packets.

2. The apparatus of claim 1, wherein the circuitry to perform load balancing is to load balance packet traffic for processing among one or more cores.

3. The apparatus of claim 1, wherein the circuitry to queue one or more packets comprises circuitry to allocate packet data exclusively to one or more queues.

4. The apparatus of claim 1, wherein the proxy comprises a microservice sidecar, wherein the microservice sidecar is to provide communications between microservices.

5. The apparatus of claim 1, wherein the remote procedure calls are made as part of communications to access a key-value store.

6. The apparatus of claim 1, wherein the circuitry to queue one or more packets is part of a network interface device.

7. The apparatus of claim 6, wherein the network interface device comprises one or more of: a network interface controller (NIC), a remote direct memory access (RDMA)-enabled NIC, SmartNIC, router, switch, forwarding element, infrastructure processing unit (IPU), or data processing unit (DPU).

8. The apparatus of claim 1, wherein at least one of the at least one processor comprises the circuitry to perform load balancing.

9. The apparatus of claim 1, comprising a server that comprises the circuitry to perform load balancing, the at least one memory, and the at least one processor.

10. A computer-readable medium comprising instructions stored thereon, that if executed by at least one processor, cause the at least one processor to:
execute a microservice communication proxy that is to allocate packet data to a load balancer to allocate workloads among cores and
allocate received and transmitted remote procedure calls to at least one queue in a queue system.

11. The computer-readable medium of claim 10, wherein the load balancer is to allocate packet traffic to one or more cores.

12. The computer-readable medium of claim 10, wherein the queue system is to allocate packet data exclusively to one or more queues.

13. The computer-readable medium of claim 10, wherein the microservice communication proxy comprises a microservice sidecar, wherein the microservice sidecar is to provide communications between microservices.

14. The computer-readable medium of claim 10, wherein the remote procedure calls are made as part of communications to access a key-value store.

15. The computer-readable medium of claim 10, wherein the queue system is part of a network interface device.

16. The computer-readable medium of claim 10, wherein at least one of the at least one processor comprises the load balancer.

17. A method comprising:
a microservice communication proxy allocating packet data to a load balancer to allocate workloads among cores and
allocating received and transmitted remote procedure calls to at least one queue in a queue system.

18. The method of claim 17, wherein the queue system allocates packet data exclusively to one or more queues.

19. The method of claim 17, wherein the queue system is part of a network interface device.

20. The method of claim 17, wherein at least one processor comprises the load balancer.
